(19) United States
(12) Patent Application Publication
(10) Pub. No.: US 2025/0153818 A1
(43) Pub. Date: May 15, 2025

(54) WATERCRAFT INFORMATION COLLECTING SYSTEM

(71) Applicant: YAMAHA HATSUDOKI KABUSHIKI KAISHA, Iwata-shi (JP)

(72) Inventors: Ryota INOUE, Shizuoka (JP); Hiroshi INOUE, Shizuoka (JP)

(21) Appl. No.: 18/940,981

(22) Filed: Nov. 8, 2024

(30) Foreign Application Priority Data
Nov. 10, 2023 (JP) 2023-192456

(51) Int. Cl. B63B 79/00

(52) U.S. Cl. CPC B63B 79/00

(57) ABSTRACT

A watercraft information collecting system includes an onboard system and a server outside a watercraft. The onboard system includes watercraft devices on the watercraft, and an onboard network on the watercraft connected to the watercraft devices. The onboard system includes a communication terminal communicable with the watercraft devices via the onboard network. The server is communicable with the communication terminal. The communication terminal is configured or programmed to perform an information collection process to collect information about the watercraft devices, a use termination detection process to detect a termination of the use of the onboard system, and an information transmission process to transmit the information collected by the information collection process to the server. The server is configured or programmed to register the information transmitted from the communication terminal in a storage.

### CROSS REFERENCE TO RELATED APPLICATIONS

This application claims the benefit of priority to Japanese Patent Application No. 2023-192456 filed on Nov. 10, 2023. The entire contents of this application are hereby incorporated herein by reference.

### BACKGROUND OF THE INVENTION

### 1. Field of the Invention

The present invention relates to watercraft information collecting systems. Further, the present invention relates to communication terminals and servers to be used with the watercraft information collecting systems. In addition, the present invention relates to watercraft each including an onboard system to be used with the watercraft information collecting systems.

### 2. Description of the Related Art

JP-2011-113538-A (paragraphs 0060 to 0061) discloses a watercraft information collecting device that collects various watercraft information during the traveling of a watercraft, and transmits information useful for watercraft maintenance management and watercraft design out of the collected watercraft information to a ground server device. The transmission of the information to the ground server device is enabled at the following four transmission timings:

(1) Periodic transmission of the watercraft information.
(2) Transmission of the watercraft information at an abnormal event.
(3) Transmission of the watercraft information based on an instruction provided by a crew member.
(4) Transmission of the watercraft information based on a request sent from a ground office.

### SUMMARY OF THE INVENTION

The inventor of example embodiments of the present invention described and claimed in the present application conducted an extensive study and research regarding a watercraft information collecting systems, such as the one described above, and in doing so, discovered and first recognized new unique challenges and previously unrecognized possibilities for improvements as described in greater detail below.

“(1) Periodic transmission of the watercraft information” means that the watercraft information is periodically transmitted at a preset time of a day (e.g., at 12:00 every day).

If an information collecting system mounted on the watercraft is out of operation at the preset time, however, the transmission of the watercraft information is not enabled and, therefore, the server device is unlikely to timely update the information accumulated therein. Where a periodic transmission interval for the periodic transmission of the watercraft information is set to a shorter period (e.g., about 10 minutes), the server device is expected to timely update the accumulated information, but communication traffic is increased and a data processing load on the server device is increased.

Example embodiments of the present invention provide watercraft information collecting systems that are able to timely update the accumulated information while preventing the communication traffic and/or the data processing load from being excessively increased, and communication terminals and servers for the watercraft information collecting system.

Another example embodiment of the present invention provides a watercraft including an onboard system to be used with the watercraft information collecting system.

In order to overcome the previously unrecognized and unsolved challenges described above, an example embodiment of the present invention provides a watercraft information collecting system including an onboard system and a server outside a watercraft. The onboard system includes a plurality of watercraft devices on the watercraft, and an onboard network on the watercraft and connected to the plurality of watercraft devices. The onboard system includes a communication terminal communicable with the plurality of watercraft devices via the onboard network. The server is communicable with the communication terminal. The communication terminal is configured or programmed to perform an information collection process to collect information about the plurality of watercraft devices, a use termination detection process to detect the termination of the use of the onboard system, and an information transmission process to transmit the information collected by the information collection process to the server. The server is configured to programmed to register the information transmitted from the communication terminal in a storage.

With this arrangement, the communication terminal, which is one of the plurality of watercraft devices provided on the onboard system, collects the information about the other watercraft devices via the onboard network, and transmits the collected information to the server. The server registers the information transmitted from the communication terminal in the storage. Thus, the information about the plurality of watercraft devices on the watercraft can be automatically accumulated in the server. The communication terminal functions to detect the termination of the use of the onboard system.

In an example embodiment of the present invention, the information transmission process includes a termination transmission process to transmit the information collected by the information collection process to the server in response to the detection of the termination of the use of the onboard system by the use termination detection process.

With this arrangement, the communication terminal performs the termination transmission process to transmit the information collected so far from the plurality of watercraft devices to the server when detecting the termination of the use of the onboard system. Thus, the information about the plurality of watercraft devices is transmitted to the server when the onboard system is terminated. Therefore, the latest information can be accumulated in the server. This makes it possible to timely update the information accumulated in the server while preventing the communication traffic or the data processing load from being excessively increased.

In an example embodiment of the present invention, the communication terminal is configured or programmed to classify the information collected by the information collection process into periodic transmission information and termination transmission information. The information transmission process further includes a periodic transmission process to transmit the periodic transmission information to the server at a predetermined periodic transmission interval during the use of the onboard system. The termination transmission process is performed to transmit the termination transmission information to the server.

With this arrangement, information classified as the periodic transmission information is accumulated in the server at the periodic transmission interval, and information classified as the termination transmission information is transmitted to the server at the termination of the onboard system. For example, the periodic transmission interval may be set to a relatively short period (e.g., about 10 minutes), and information indicating the state of the onboard system during use (i.e., the operation state of the watercraft during traveling) may be classified as the periodic transmission information. Thus, information about the constantly changing state of the onboard system can be accumulated in the server substantially on a real time basis. On the other hand, where non-real time information is classified as the termination transmission information and is not periodically transmitted, for example, it is possible to reduce the communication traffic and correspondingly alleviate the processing load on the server in the periodic transmission process.

In an example embodiment of the present invention, the plurality of watercraft devices include a propulsion device including an engine (internal combustion engine) as a power source. The termination transmission information preferably includes one or more of a maximum engine speed, an over-revolution count, an overheat count, a lower oil pressure count, a knocking control count, a rapid acceleration count, a reverse rotation count, an engine speed range-based operation period, a shift count, a start count, or a fuel tank volume.

With this arrangement, the latest information about the engine can be registered in the server by the termination transmission process. Thus, the server can perform processes with the use of the latest information about the engine. For example, the server may perform a process to estimate the maintenance time of the engine, and may perform a process to notify a user or the like about the estimated maintenance time.

In an example embodiment of the present invention, the plurality of watercraft devices include a steering device including a steering actuator. The termination transmission information preferably includes one or more of a load range-based steering actuator driving period or a total steering operation angle.

With this arrangement, the latest information of the steering device can be registered in the server by the termination transmission process. Thus, the server can perform processes with the use of the latest information about the steering device. For example, the server may perform a process to estimate the maintenance time of the steering device, and may perform a process to notify the user or the like about the estimated maintenance time.

In an example embodiment of the present invention, the plurality of watercraft devices include a propulsion device including an engine (internal combustion engine) as a power source. The periodic transmission information includes one or more of an engine speed, a coolant pressure, a total engine operation period, a fuel consumption rate, a trouble code, a residual battery capacity, a watercraft speed, an ignition timing, a fuel injection period, a fuel pressure, or an engine temperature.

Thus, the information about the engine can be accumulated in the server at the periodic transmission interval. Thus, a change in the information can be accumulated in the server during the use of the onboard system. The server may perform processes based on the accumulated information, for example, to determine whether or not any abnormality is present and whether or not a maintenance is necessary, to estimate the maintenance time and to notify the user or the like about the presence/absence of the abnormality, the necessity/unnecessity of the maintenance, and/or the maintenance time.

In an example embodiment of the present invention, the termination transmission information includes information usable as an index to estimate the maintenance time of any of the plurality of watercraft devices in the onboard system (for inspection, parts replacement and the like).

With this arrangement, the latest information usable as the index to estimate the maintenance time of any of the watercraft devices (for the inspection, the parts replacement and the like) can be accumulated in the server by the termination transmission process. Thus, the server can properly perform the process to estimate the maintenance time.

In an example embodiment of the present invention, the server is configured or programmed to perform a notification process to notify about the maintenance time based on the termination transmission information. With this arrangement, the maintenance time is properly estimated based on the information accumulated in the server by the termination transmission process so that the user or the like can be notified about the properly estimated maintenance time. Thus, the user or the like can timely take measures for maintenance.

The notification about the maintenance time may be mail transmitted to the user or the like, or may be a notification provided in an application incorporated in an information terminal being used by the user or the like. The information terminal may be a mobile terminal such as a smartphone.

In an example embodiment of the present invention, the watercraft information collecting system includes a communication terminal power supply that maintains power supply to the communication terminal at least until the termination transmission process ends after the termination of the use of the onboard system. With this arrangement, the power supply to the communication terminal is maintained even after the termination of the use of the onboard system. Therefore, the communication terminal can reliably perform the termination transmission process.

The communication terminal power supply may be a power storage incorporated in the communication terminal. The incorporated power storage may be a battery, or may be a capacitor (electric double layer capacitor or the like). The incorporated power storage may be charged with electric power from an onboard system main battery. Further, the communication terminal power supply may be a power supply maintaining circuit that maintains a connection between the onboard system main battery and the communication terminal even after the termination of the use of the onboard system.

Another example embodiment of the present invention provides a watercraft including a hull, and the onboard system for use in the watercraft information collecting system including any of the aforementioned features.

Further another example embodiment of the present invention provides the communication terminal for use in the watercraft information collecting system including any of the aforementioned features.

Still another example embodiment of the present invention provides the server for use in the watercraft information collecting system including any of the aforementioned features.

Further another example embodiment of the present invention provides a communication terminal to be mounted on a watercraft and communicable with a server. The communication terminal includes a communication interface connected to an onboard network on the watercraft, a wireless communicator to communicate with the server, and a processor. The processor is configured or programmed to function as an information collector to collect information about the plurality of watercraft devices on the watercraft and connected to the onboard network via the communication interface, as a use termination detector to detect the termination of the use of the onboard system, and as an information transmitter to cause the wireless communicator to transmit the information collected by the information collector to the server.

In an example embodiment of the present invention, the information transmitter performs a termination transmission process to transmit the information collected by the information collector to the server in response to the detection of the termination of the use of the onboard system by the use termination detector.

In an example embodiment of the present invention, the processor is configured or programmed to function as a classifier to classify the information collected by the information collector into periodic transmission information and termination transmission information. The information transmitter further performs a periodic transmission process to transmit the periodic transmission information to the server at a predetermined periodic transmission interval during the use of the onboard system and, in the termination transmission process, transmits the termination transmission information to the server.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram that outlines a watercraft information collecting system according to an example embodiment of the present invention.

FIG. 2 is a block diagram that describes the configuration of a watercraft by way of example.

FIG. 3 is a block diagram that describes the configuration of a server by way of example.

FIG. 4 is a block diagram showing the configuration of a communication terminal by way of example.

FIG. 5A is a block diagram that describes the configuration of a dealer client by way of example.

FIG. 5B is a block diagram that describes the configuration of a user client by way of example.

FIG. 6 is a flowchart that describes an exemplary operation to be performed by the communication terminal.

FIG. 7 is a diagram that describes a periodic transmission process to be performed by the communication terminal by way of example.

FIG. 8 is a diagram that describes a termination process to be performed by the communication terminal by way of example.

FIG. 9 is a flowchart that describes an exemplary operation to be performed by the server.

### DETAILED DESCRIPTION OF THE EXAMPLE EMBODIMENTS

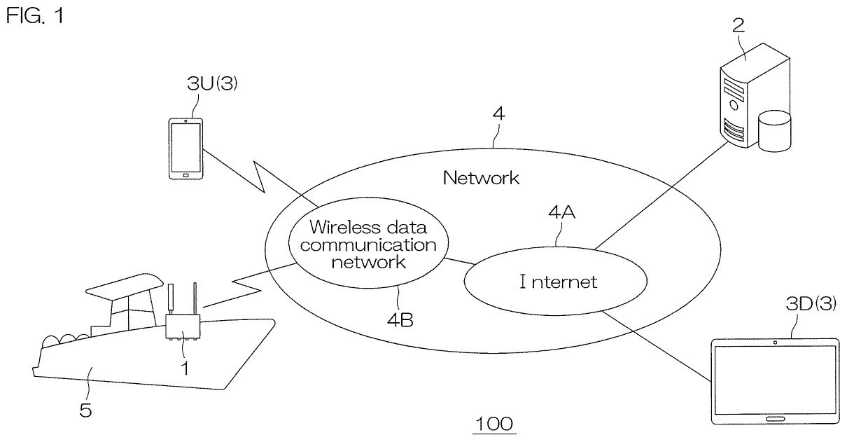

FIG. 1 is a diagram that outlines a watercraft information collecting system according to an example embodiment of the present invention. The watercraft information collecting system 100 includes a communication terminal 1 to collect and transmit information about devices provided on a watercraft 5, and a server 2 to communicate with the communication terminal 1. The communication terminal 1 may be provided on the watercraft 5. Further, the communication terminal 1 may be portable so that a crew member can bring the communication terminal 1 onto the watercraft 5.

The communication terminal 1 and the server 2 are communicable with each other via a network 4. That is, the communication terminal 1 and the server 2 are each connected to the network 4 in a communicable manner. The network 4 typically includes an internet 4A. The communication terminal 1 is connected to a wireless data communication network 4B such as a mobile phone network in a communicable manner, and is connected to the internet 4A via the wireless data communication network 4B in a communicable manner.

The server 2 is typically communicable with a client 3. The client 3 may be a client terminal provided in a dealer office and/or a marina office (hereinafter referred to as “dealer client 3D”). Further, the client 3 may be a mobile terminal such as a smartphone to be carried by a user (hereinafter referred to as “user client 3U”). The dealer client 3D may be configured to be connectable to the internet 4A via a local area network (not shown) provided in the office, or may be configured to be connectable to the internet 4A via the wireless data communication network 4B. The user client 3U is typically configured to be connectable to the internet 4A via the wireless data communication network 4B. Further, the user client 3U may be connected to the communication terminal 1 in a data communicable manner in the watercraft. In this case, the user client 3U may be connectable to the network 4 via the communication terminal 1.

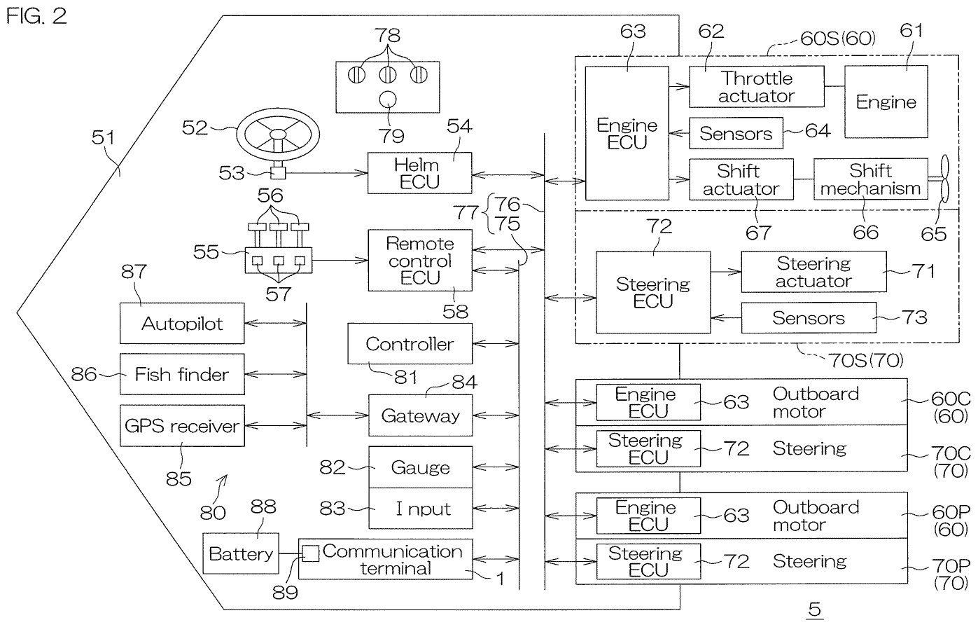

FIG. 2 is a block diagram that describes the configuration of the watercraft 5 by way of example. The watercraft 5 includes a hull 51, and various devices provided on the hull 51 (watercraft devices). The watercraft devices typically include an input device to maneuver the watercraft 5 (watercraft maneuvering device), a controller 81 to comprehensively control the devices provided on the watercraft 5, a propulsion device to apply a propulsive force to the hull 51, and a steering device (watercraft maneuvering device) to change the advancing direction of the hull 51. In this example embodiment, the communication terminal 1 is one of the watercraft devices.

In this example, the input device includes a steering wheel 52 and a remote controller 55.

In this example, the propulsion device includes an outboard motor 60 as an exemplary main device (main propulsion device). Specifically, the outboard motor 60 includes one or more outboard motors 60 provided on the stern of the hull 51. In this example, a plurality of outboard motors 60 (more specifically, three outboard motors 60) are disposed side by side and attached to the stern. In this example, the outboard motors 60 are engine outboard motors each including an engine 61 (internal combustion engine) as a power source to drive a propeller 65. Of course, electric outboard motors each including an electric motor as a power source may be used. Specifically, the three outboard motors 60 include a middle outboard motor 60C disposed in the middle, and a port-side outboard motor 60P and a starboard-side outboard motor 60S disposed on the left side and the right side, respectively, of the middle outboard motor 60C.

In this example, the steering device includes steerings 70 to respectively steer the outboard motors 60 leftward and rightward. The steerings 70 are provided in one-to-one correspondence with the outboard motors 60. In this example, three steerings 70 are provided. The three steerings 70 include a middle steering 70C, a port-side steering 70P and a starboard-side steering 70S, which correspond to the middle outboard motor 60C, the port-side outboard motor 60P and the starboard-side outboard motor 60S, respectively.

The steering wheel 52 is turned by a user (watercraft operator). The operation angle of the steering wheel 52 is detected by an operation angle sensor 53, and inputted to a helm ECU (Electronic Control Unit) 54. The remote controller 55 includes acceleration levers 56 to be operated by the user to adjust the directions (forward or reverse directions) and the magnitudes of propulsive forces to be generated by the respective outboard motors 60. The operation positions of the acceleration levers 56 are respectively detected by acceleration position sensors 57, and inputted to a remote control ECU 58.

The outboard motors 60 each include the engine 61, the propeller 65 that is driven by the engine 61, a shift mechanism 66, and an engine ECU 63. The shift mechanism 66 has a plurality of shift positions, i.e., a forward shift position, a reverse shift position and a neutral shift position. With the shift position set to the forward shift position, the propeller 65 is rotated in the forward rotation direction by the driving force of the engine 61. With the shift position set to the reverse shift position, the propeller 65 is rotated in a reverse rotation direction by the driving force of the engine 61. With the shift position set to the neutral shift position, power transmission between the engine 61 and the propeller 65 is cut off. The engine ECU 63 controls the operation of a shift actuator 67 that actuates the shift mechanism 66 to control the direction of the propulsive force. Further, the engine ECU 63 controls the operation of a throttle actuator 62 that drives the throttle valve of the engine 61 to control the magnitude of the propulsive force.

The steerings 70 each include a steering actuator 71, and a steering ECU 72 to control the steering actuator 71. The steering actuator 71 generates power to pivot the corresponding outboard motor 60 leftward and rightward about its steering shaft (not shown). Thus, the direction of the propulsive force applied to the hull 51 by the outboard motor 60 is changed leftward and rightward such that the advancing direction of the watercraft 5 is changed. The steering 70 may be unitary with the corresponding outboard motor 60, or may be separate from the outboard motor 60. In FIG. 2, the steering 70 and the outboard motor 60 are configured as a unitary unit by way of example (e.g., the steering 70 is incorporated in the outboard motor 60).

A data communication network, i.e., an onboard network 77, is provided in the watercraft 5. In this example embodiment, the onboard network 77 includes a watercraft control CAN (Control Area Network) 75 and a propulsion device control CAN 76. The onboard network 77 may further include a multiplicity of daughter networks. An onboard system 80 includes the onboard network 77 and various watercraft devices connected to the onboard network 77.

The remote control ECU 58, the helm ECU 54, the engine ECUs 63 and the steering ECUs 72 are connected to the propulsion device control CAN 76. Therefore, an output command from the remote control ECU 58 is transmitted to the engine ECUs 63 via the propulsion device control CAN 76. The output command is a command signal indicating the directions (forward or reverse directions) of the propulsive forces of the respective outboard motors 60. Further, a steering command from the helm ECU 54 is transmitted to the steering ECUs 72 via the propulsion device control CAN 76. The steering command is a command signal corresponding to the operation direction (turning direction) and the operation angle of the steering wheel 52 and indicating the steering directions and the steering angles of the outboard motors 60.

The remote control ECU 58 is also connected to the watercraft control CAN 75. The controller 81 is further connected to the watercraft control CAN 75. Therefore, the controller 81 can acquire information about the output command from the remote control ECU 58.

Further, the controller 81 is able to acquire various information from the watercraft devices connected to the propulsion device control CAN 76, more specifically from the helm ECU 54, the engine ECUs 63 and the steering ECUs 72, via the remote control ECU 58.

Therefore, the controller 81 is able to acquire information about the steering command outputted from the helm ECU 54. Further, the controller 81 is able to acquire, for example, the information about the steering command received by the steering ECUs 72, and information about the detection results of various sensors 73 provided on each of the steerings 70. The sensors 73 include, for example, a steering angle sensor. The steering angle sensor of the steering 70 detects the actual steering angle of the corresponding outboard motor 60. The steering angle sensor may detect the operation amount of the steering actuator 71. Further, the controller 81 can acquire various information from the engine ECUs 63. For example, the controller 81 is able to acquire information about the output command received by the engine ECUs 63, and information about the detection results of various sensors 64 provided on each of the outboard motors 60. The sensors 64 include, for example, a throttle opening degree sensor, an engine speed sensor, an engine temperature sensor, a coolant pressure sensor, an oil pressure sensor, a shift position sensor, a fuel pressure sensor and a residual fuel amount sensor. The throttle opening degree sensor detects the throttle valve opening degree of the engine 61 of the outboard motor 60. The engine speed sensor detects the rotation speed of the engine 61 (engine speed), and may be a crank angle sensor. The engine ECU 63 may be operable to process the output of the crank angle sensor to generate engine speed information. The engine temperature sensor may detect the cylinder block temperature (e.g., coolant temperature) of the engine 61, or may detect the exhaust temperature of the engine 61. The coolant pressure sensor detects the pressure of a coolant for the cooling of the engine 61. The oil pressure sensor detects the oil pressure of the engine 61. The shift position sensor detects the shift position of the shift mechanism 66 of the outboard motor 60. The fuel pressure sensor detects the pressure of a fuel supplied to the engine 61. The residual fuel amount sensor detects the amount of residual fuel in a fuel tank.

The communication terminal 1 and a gauge 82 to display various information are further connected to the watercraft control CAN 75. The communication terminal 1 is configured or programmed to transmit information about the state of the watercraft 5 and the like to the server 2, more specifically, to transmit configuration information indicating the configuration of the watercraft 5 (particularly, the onboard system 80), failure information indicating a failure occurring in the onboard system 80, the detection values of the sensors, and the like to the server 2 (see FIG. 1).

The gauge 82 functions as a display to display, for example, the residual fuel amount, the engine speeds and the shift positions of the respective outboard motors 60, a residual battery capacity, and the like. The residual battery capacity is the residual capacity of a battery 88 mounted on the hull 51 to actuate starter motors (not shown) incorporated in the respective outboard motors 60 for engine start. The battery 88 discharges for the engine start, and is charged by power generators (not shown) incorporated in the respective outboard motors 60 during the operation of the engines 61. The gauge 82 may include an input device 83 such as input buttons and a touch panel. The input device 83 may be configured to be operated by the user to input various commands. The input device 83 may be provided separately from the gauge 82.

Other various watercraft devices may be connected to the watercraft control CAN 75 in a data communicable manner. Third party watercraft devices are typically connected to the watercraft control CAN 75 via a gateway 84. In FIG. 2, a GPS (Global Positioning System) receiver 85, a fish finder 86 and an autopilot device 87 are shown as examples of third party watercraft devices. The GPS receiver 85 is an example of GNSS (Global Navigation Satellite System) positioning system, which detects the position of the watercraft 5.

The steering wheel 52 and the remote controller 55 are disposed in association with a helm seat, and main switches 78 to be operated to turn on and off power supply to the respective outboard motors 60 and to start and stop the engines 61 of the respective outboard motors 60 are also provided in association with the helm seat. Further, a kill switch 79 (emergency stop switch) to be operated to nullify the propulsive forces of the outboard motors 60 (typically to stop the engines 61) in an emergency is provided in association with the helm seat. The kill switch 79 has, for example, an operation end to which a lanyard cable carried by the user is connected. When the user falls overboard, the kill switch 79 is actuated for the emergency stop of the engines 61 of the outboard motors 60.

The communication terminal 1 is configured or programmed to be operative while receiving electric power from a communication terminal power supply 89. In this example embodiment, the communication terminal power supply 89 is incorporated in the communication terminal 1, but may be provided outside the communication terminal 1. An example of the communication terminal power supply 89 is a communication terminal battery or a communication terminal capacitor (typically, an electric double layer capacitor). In this case, the communication terminal power supply 89 preferably includes a charging circuit that charges the communication terminal battery or the communication terminal capacitor with the electric power from the battery 88 (main battery). The charging circuit may be configured to stop the charging of the communication terminal battery or the communication terminal capacitor if the voltage of the battery 88 is lower than a predetermined threshold. Another example of the communication terminal power supply 89 is a power supply maintaining circuit. The power supply maintaining circuit is configured to maintain the power supply to the communication terminal 1 from the battery 88 at least until a termination process to be described below ends even after the power supply to the onboard system 80 is stopped. Thus, the operation state of the communication terminal 1 can be maintained at least during the termination process even after the termination of the use of the onboard system 80. The power supply maintaining circuit may be configured so as not to disconnect the battery 88 from the communication terminal 1 even if the onboard system 80 is out of use. Further, the power supply maintaining circuit may include a disconnection delay circuit that delays the disconnection of the battery 88 from the communication terminal 1 later than the termination of the use of the onboard system 80.

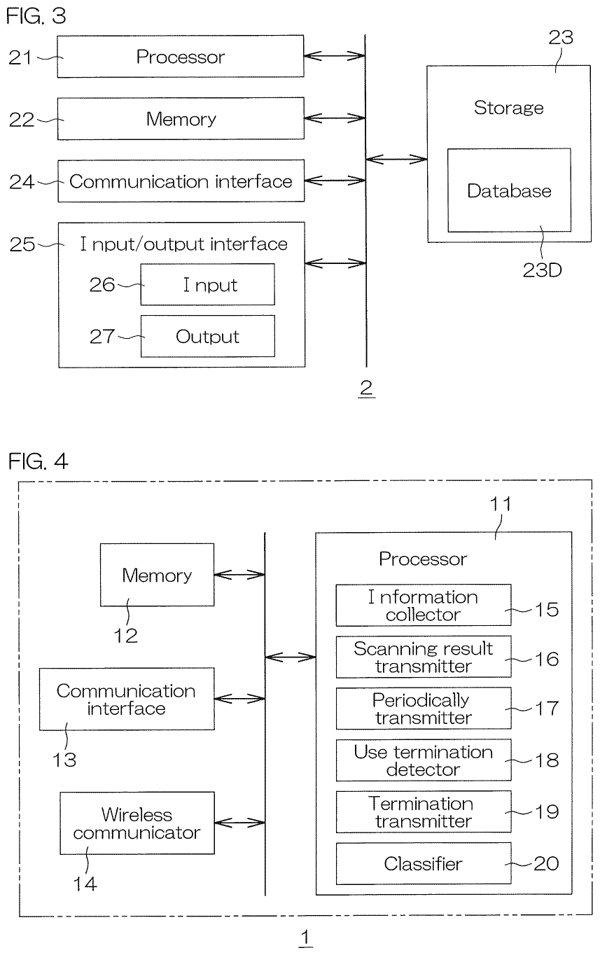

FIG. 3 is a block diagram that describes the configuration of the server 2 by way of example. The server 2 has a basic configuration as a computer. That is, the server 2 includes a processor 21, a memory 22, a storage 23, a communication interface 24 and an input/output interface 25, which are connected to each other in a data communicable manner.

The processor 21 is operative according to a program stored in the memory 22 to perform various functions. Specifically, the server 2 functions to communicate with the communication terminal 1 (see FIG. 1) to collect data from the communication terminal 1 and to accumulate the data in the storage 23. Further, the server 2 functions to communicate with the dealer client 3D (see FIG. 1) to provide a webpage to the dealer client 3D and to provide a web application service on the webpage. A web application program is stored in the memory 22 to provide the web application service. Further, the server 2 functions to communicate with the user client 3U (see FIG. 1) to provide information to an application provided in the user client 3U. The storage 23 provides a storage area for the accumulation of the data. The communication interface 24 interfaces with the network 4 for communications. The input/output interface 25 includes an input device 26 (e.g., a keyboard) and an output device 27 (e.g., a display) to serve as a man-machine interface.

A database 23D is provided in the storage 23 and, for a plurality of watercraft, configuration information indicating the configuration of the onboard system 80 of each individual watercraft is accumulated in the database 23D. The configuration information to be accumulated for the plurality of watercraft 5 includes configuration information transmitted from the communication terminal 1 of the each individual watercraft 5. The configuration information includes information about one or more of the watercraft devices of the onboard system 80. The configuration information about the watercraft devices may include information indicating the types (model names), the component numbers, the serial numbers, the software names, the software versions and the like of the watercraft devices. The configuration information may further include at least one (preferably all) of the number, the layout or the connection states of the watercraft devices. Particularly, the configuration information preferably includes information about the types (model names), the number, the layout and the connection states of the outboard motors 60 as the main devices and the steerings 70 respectively incorporated in the outboard motors 60.

Periodic transmission information to be periodically transmitted from the communication terminal 1 of the each individual watercraft 5 is stored in the database 23D. Further, termination transmission information to be transmitted from the communication terminal 1 of the each individual watercraft 5 at the termination of the onboard system 80 of the each individual watercraft 5 is stored in the database 23D. That is, the processor 21 receives the periodic transmission information, and stores the received periodic transmission information in the database 23D. Further, the processor 21 receives the termination transmission information, and stores the received termination transmission information in the database 23D.

The processor 21 performs processes with the use of one or both of the periodic transmission information and the termination transmission information.

For example, the processor 21 may perform a maintenance time estimation process to estimate a maintenance time with the use of the periodic transmission information and/or the termination transmission information. The maintenance time estimation process may include a service time estimation process to be performed to estimate a service time at which a dealer is to perform a service (for oil change or the like), and may include a parts replacement time estimation process to be performed to estimate a parts replacement time. The processor 21 may perform a maintenance time notification process to notify the user (typically, a watercraft owner) or a dealer about the maintenance time based on the result of the maintenance time estimation process. The maintenance time notification process may include a notification on the webpage provided to the dealer client 3D, and may include a notification on the application of the user client 3U. Further, the maintenance time notification process may include transmission of mail to a registered mail address of the user and/or the dealer.

The processor 21 may perform a troubleshooting process with the use of the periodic transmission information and/or the termination transmission information. The troubleshooting process typically includes an abnormality detection process to be performed to detect an abnormality, and preferably further includes an abnormality notification process to be performed to notify the user or the dealer about the detected abnormality. Like the maintenance time notification process, the abnormality notification process may include a notification on the webpage provided to the dealer client 3D, and may include a notification on the application of the user client 3U. Further, the abnormality notification process may include transmission of mail to the registered mail address of the user and/or the dealer. The troubleshooting process may further include an information generation process to be performed to generate information about an abnormality cause identification process to identify the cause of the abnormality and information about an abnormality elimination process to eliminate the abnormality. The information generated by these processes may be covered by the notification processes described above.

FIG. 4 is a block diagram showing the configuration of the communication terminal 1 by way of example. The communication terminal 1 includes a processor 11, a memory 12, a communication interface 13 and a wireless communicator 14. The processor 11 is operative according to a program stored in the memory 12 to perform a plurality of functions. The communication interface 13 is configured for data communications via the onboard network 77. The wireless communicator 14 is configured for data communications with the server 2 via the network 4.

The processor 11 performs a data collecting function to collect information from the devices provided on the hull 51 via the onboard network 77 and store the collected information in the memory 12. The information to be collected include the configuration information about the devices (watercraft devices) provided on the hull 51. Further, the information to be collected may include the detection values of the various sensors. Specifically, the processor 11 is able to collect the detection values of the sensors 53, 57, 64, 73 connected to the helm ECU 54, the remote control ECU 58, the steering ECUs 72 and the engine ECUs 63. The information to be collected may further include information generated by the helm ECU 54, the remote control ECU 58, the steering ECUs 72 and the engine ECUs 63. The information may include control information (control commands and other data) to be generated in the ECUs, trouble information (error codes and the like) detected by the ECUs, and the like. The main switches 78, the kill switch 79, a start switch and other switches are regarded as sensors, and the states of these switches may be collected as the detection values. Further, the processor 11 may have a trouble detecting function of monitoring the states of the various devices connected to the onboard network 77 and generating trouble information (failure information). For example, the processor 11 may be operable to monitor the states of the ECUs and detect the interruption of the operations of the ECUs due to the instantaneous drop of a supply voltage as a trouble (instantaneous power failure). The collected information, the generated trouble information and the like are stored in the memory 12. The processor 11 is not necessarily required to collect information from all the devices connected to the onboard network 77. For example, the processor 11 is not required to cover the third party devices connected to the onboard network 77 via the gateway 84.

The processor 11 functions to transmit a portion or all of the information collected and/or generated by itself and stored in the memory 12 to the server 2 via the wireless communicator 14.

In this example embodiment, the processor 11 functions as an information collector 15 to collect information from the watercraft devices connected to the onboard network 77 via the communication interface 13. One function of the information collector 15 is to perform a system scanning process to collect the configuration information about the watercraft devices connected to the onboard network 77. The processor 11 functions as a scan result transmitter 16 to perform a scan result transmission process to cause the wireless communicator 14 to transmit the information collected by the system scanning process as a scan result to the server 2. The server 2 receives the scan result, and registers the scan result as the configuration information about the onboard system 80 in the database 23D.

The processor 11 stores the information collected by the system scanning process as the scan result in the memory 12. That is, in this example embodiment, the memory 12 is used as a scan result memory.

The processor 11 performs the system scanning process at the startup of the onboard system 80. Further, the processor 11 performs the system scanning process when an additional watercraft device is incorporated into the onboard network 77 to change the configuration of the onboard system 80.

The information collector 15 does not only collect the information by the system scanning process, but also collects various information from the watercraft devices via the onboard network 77 during the operation of the onboard system 80. The processor 11 functions as a periodic transmitter 17 to perform a periodic transmission process to transmit predetermined periodic transmission information to the server 2 at a predetermined periodic transmission interval during the operation of the onboard system 80. The periodic transmission interval may be, for example, about ten minutes. The periodic transmission information includes the information collected by the information collector 15 and includes, for example, operation information indicating the operation states of the outboard motors 60 (propulsion device). The periodic transmission information is uploaded to the server 2 to be accumulated in the database 23D, and is mainly used to later investigate into the presence/absence of any abnormality and a situation in which the abnormality occurs, and the like.

The periodic transmission information includes an error code as required. Specifically, when an error code indicating the presence of an error at the startup of the onboard system 80 appears on the onboard network 77, the error code is incorporated in the periodic transmission information. If the error code is thereafter changed to another error code during the operation of the onboard system 80, the another error code is incorporated in the periodic transmission information. The transmission of the error code to the server 2 may be performed separately from the periodic transmission process.

The processor 11 further functions as a use termination detector 18 to detect the termination of the use of the onboard system 80. Further, the processor 11 functions as a termination transmitter 19 to perform a termination transmission process to transmit predetermined termination transmission information out of the information collected by the information collector 15 to the server 2 when the termination of the use of the onboard system 80 is detected.

For example, the use termination detector 18 may be configured to monitor information periodically appearing on the onboard network 77 and, when the information no longer periodically appears, determine that the use of the onboard system 80 is terminated. When the power supply to the onboard system 80 is on, for example, the engine ECUs 63 are in operation, and periodically output engine speed data to the onboard network 77. Therefore, if no engine speed data appears on the onboard network 77 for longer than a certain period of time, the use termination detector 18 may determine that the use of the onboard system 80 is terminated.

The termination transmitter 19 performs the termination transmission process when the use termination detector 18 detects the termination of the use of the onboard system 80. The termination transmission information uploaded to the server 2 by the termination transmission process is accumulated in the database 23D, and is used as information to estimate the maintenance time, as information for the troubleshooting, and as reference information for product development.

The processor 11 functions as a classifier 20 to extract information classified as the periodic transmission information and information classified as the termination transmission information from the information collected by the information collector 15. The periodic transmission information and the termination transmission information thus classified and extracted are transmitted to the server 2 by the periodic transmitter 17 and the termination transmitter 19, respectively. The periodic transmitter 17 and the termination transmitter 19 are examples of the information transmitter.

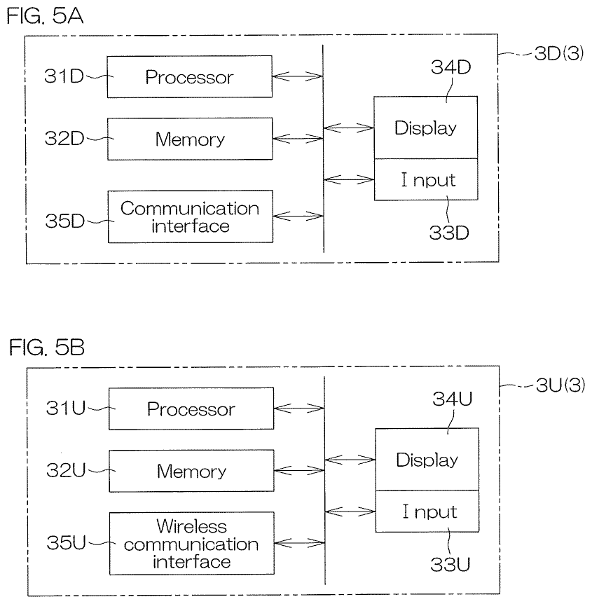

FIG. 5A is a block diagram that describes the configuration of the dealer client 3D by way of example. The dealer client 3D has a basic configuration as a computer. For example, the dealer client 3D may be a personal computer of clamshell type or tablet type.

The dealer client 3D includes a processor 31D, a memory 32D, an input device 33D, a display 34D and a communication interface 35D. The processor 31D executes a program stored in the memory 32D to perform various functions. The input device 33D may be a touch panel provided on the display screen of the display 34D. The communication interface 35D interfaces with the network 4 for data communications. The communication interface 35D may communicate with the network 4 (see FIG. 1) via the local area network (not shown) provided in the dealer office, the marina office or the like through cable or wireless data communications. Further, the communication interface 35D may be configured to be connectable to the wireless data communication network 4B (see FIG. 1).

In the memory 32D, at least a web browser program is stored. The processor 31D executes the web browser program such that the user of the dealer client 3D (dealer staff, marina staff or the like) can browse the webpage provided by the server 2 to use the web application service provided on the webpage.

The user of the dealer client 3D can display the webpage on the display 34D. On the webpage thus displayed, the user of the dealer client 3D can receive information from the server 2. Specifically, the user of the dealer client 3D can acquire information about a trouble occurring in a customer's watercraft 5 and information about the maintenance time of the customer's watercraft 5.

Further, an e-mail receiving program (mailer) may be stored in the memory 32D. The processor 31D executes the e-mail receiving program such that the user of the dealer client 3D can receive an e-mail transmitted from the server 2. Thus, the notification about the trouble occurring in the customer's watercraft 5 and the notification about the maintenance time of the customer's watercraft 5 can be obtained from the server 2 by e-mails.

FIG. 5B is a block diagram that describes the configuration of the user client 3U by way of example. The user client 3U has a basic configuration as a computer. More specifically, the user client 3U has a basic configuration as a mobile terminal, still more specifically, has a basic configuration as a smartphone. The user client 3U includes a processor 31U, a memory 32U, an input device 33U, a display 34U and a wireless communication interface 35U.

The processor 31U executes a program stored in the memory 32U to perform various functions. The input device 33U may be a touch panel provided on the display screen of the display 34U. The wireless communication interface 35U interfaces with the network 4 (more specifically, the wireless data communication network 4B) for data communications. The wireless communication interface 35U may be configured to interface with the onboard network 77 for data communications. In this case, the user client 3U can be connected to the network 4 via the onboard network 77 and the communication terminal 1, allowing for data communications with the server 2.

An application program executable by the processor 31U (so-called native application program) is stored in the memory 32U. The processor 31U executes the native application program such that the user of the user client 3U (typically, the user or the owner of the watercraft 5) can acquire the information provided by the server 2 and display the information on the screen of the application program. Specifically, the application program makes it possible to acquire the information about the trouble occurring in the watercraft 5 and the information about the maintenance time of the watercraft 5, and the like.

Further, an e-mail receiving program (mailer) may be stored in the memory 32U. The processor 31U executes the e-mail receiving program such that the user of the user client 3U can receive an e-mail transmitted from the server 2. Thus, the notification about the trouble occurring in the customer's watercraft 5 and the notification about the maintenance time of the customer's watercraft 5 can be obtained from the server 2 by e-mail.

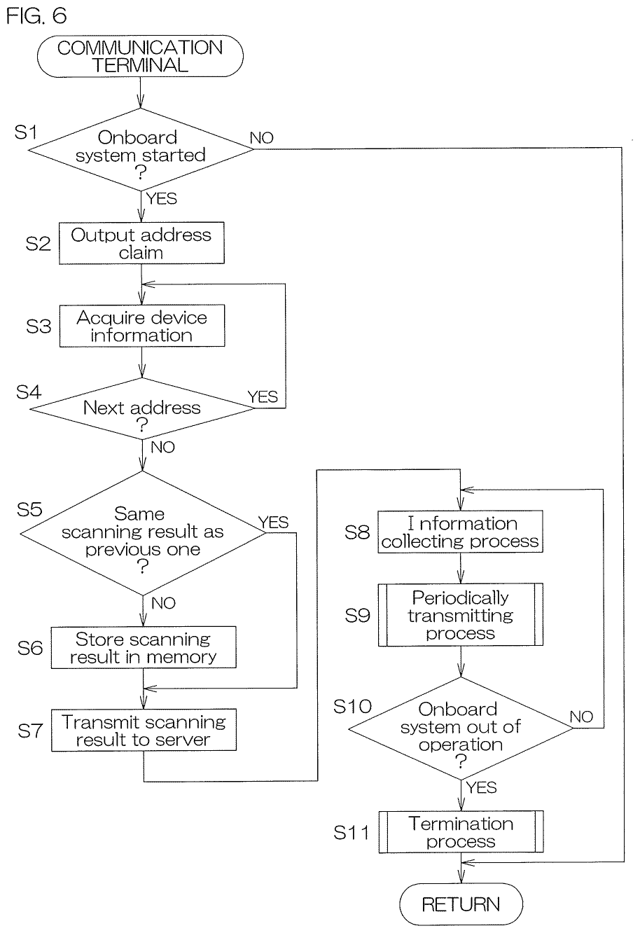

FIG. 6 is a flowchart that describes an exemplary operation to be performed by the communication terminal 1, mainly showing an exemplary process to be periodically performed by the processor 11 (see FIG. 4). The communication terminal 1 monitors the onboard system 80 for startup and, if the onboard system 80 is started (YES in Step S1), the communication terminal 1 performs a watercraft device information acquisition process to acquire information about the watercraft devices connected to the onboard network 77. When a message is outputted from any of the watercraft devices to the onboard network 77, for example, the communication terminal 1 may determine that the onboard system 80 is started. More specifically, when the message appears on the watercraft control CAN 75, the communication terminal 1 may determine that the onboard system 80 is started.

In order to acquire the information about the watercraft devices connected to the onboard network 77, the communication terminal 1 acquires the addresses of the watercraft devices connected to the watercraft control CAN 75 (Step S2). For the acquisition of the addresses, the communication terminal 1 may output an address claim to the onboard network 77 (specifically, to the watercraft control CAN 75) to claim its own address. The watercraft devices connected to the watercraft control CAN 75 are each configured to output an address claim to claim an address to be used in response to the address claim outputted to the watercraft control CAN 75 by the communication terminal 1. Thus, the communication terminal 1 can acquire the addresses of the respective watercraft devices connected to the watercraft control CAN 75 by outputting the address claim to the watercraft control CAN 75.

Next, the communication terminal 1 performs the system scanning process. Specifically, the communication terminal 1 transmits a configuration information transmission request to one of the watercraft devices connected to the onboard network 77 (more specifically, to the watercraft control CAN 75) at any specific one of the acquired addresses. In response to the request, the watercraft device at the specific address transmits its configuration information to the communication terminal 1. The communication terminal 1 receives the configuration information, and stores the received configuration information in the memory 12. Thus, the configuration information about the watercraft device is acquired (Step S3). This process is performed repeatedly for all the watercraft devices at the acquired addresses (Step S4) such that the configuration information is acquired for all the watercraft devices connected to the onboard network 77.

The remote control ECU 58 collects information from the watercraft devices (the helm ECU 54, the engine ECUs 63 and the steering ECUs 72) connected to the propulsion device control CAN 76. That is, upon reception of the configuration information transmission request, the remote control ECU 58 does not only transmit its configuration information to the communication terminal 1, but also collects configuration information about the watercraft devices connected to the propulsion device control CAN 76 and transmits the collected configuration information to the communication terminal 1. Thus, the configuration information is collected for all the watercraft devices connected to the onboard network 77. The configuration information thus acquired by the system scanning process is the scanning result, and data indicating the scanning result is referred to as “scanning result data.” The configuration information about the communication terminal 1 itself is also included as the scanning result data.

The communication terminal 1 reads out previous scanning result data from the memory 12, and compares new (latest) scanning result data with the previous scanning result data to determine whether the new scanning result and the previous scanning result are consistent or inconsistent with each other (Step S5). If the previous scanning result data is not stored in the memory 12, the result of the determination is inconsistent. If the new scanning result is inconsistent with the previous scanning result (NO in Step S5), the communication terminal 1 stores the new scanning result data in the memory 12 (Step S6), and transmits the new scanning result data to the server 2 (Step S7).

The communication terminal 1 collects the information transmitted from the watercraft devices to the onboard network 77 during the operation of the onboard system 80, and stores the collected information in the memory 12 (Step S8, an information collection process as the function of the information collector 15). Then, the communication terminal 1 performs the periodic transmission process to periodically transmit predetermined periodic transmission information out of the collected information (Step S9). The communication terminal 1 monitors whether or not the use of the onboard system 80 is continued, i.e., whether or not the onboard system 80 is in operation (Step S10, a use termination detection process as the function of the use termination detector 18). If the onboard system 80 is in operation, the information collection process (Step S8) and the periodic transmission process (Step S9, the information transmission process) are continued. If the termination of the use of the onboard system 80 is detected (YES in Step S10), the communication terminal 1 performs the termination process. The termination process includes the termination transmission process (information transmission process) to be performed to transmit the predetermined termination transmission information out of the information collected by the information collection process (Step S8).

Whether or not the onboard system 80 is in operation (in use) can be detected (Step S10), for example, by monitoring the information periodically appearing on the onboard network 77 as described above. For example, when the power supply to the onboard system 80 is on, the engine ECUs 63 are in operation to periodically output the engine speed data to the onboard network 77. Therefore, if no engine speed data appears on the onboard network 77 for longer than the predetermined period of time, the communication terminal 1 may determine that the use of the onboard system 80 is terminated.

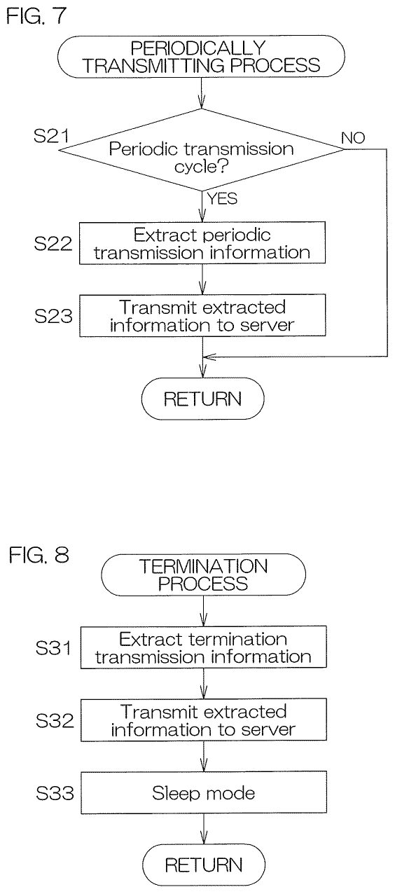

FIG. 7 is a flow chart that describes an example of the periodic transmission process (Step S9 in FIG. 6) to be performed by the communication terminal 1 when the onboard system 80 is in operation. In every periodic transmission cycle (occurring, for example, at a periodic transmission interval of 10 minutes) (YES in Step S21), the communication terminal 1 transmits the periodic transmission information to the server 2. More specifically, predefined information classified as the periodic transmission information is extracted from the information stored in the memory 12 by the information collection process (Step S8 in FIG. 6) (Step S22, the function of the classifier 20), and the extracted information is transmitted as the periodic transmission information to the server 2 (Step S23, the function of the periodic transmitter 17).

The periodic transmission information includes the operation information of the outboard motors 60, more specifically, engine operation information. The engine operation information includes, for example, information about engine operation periods for a plurality of predefined engine speed ranges. The engine operation information may further include an over-revolution count, an overheat count, a lower oil pressure count, a knocking control count, a reverse rotation count, or the like. The periodic transmission information may further include information about the detection values of the various sensors. The communication terminal 1 periodically collects the engine operation information and the detection values of the sensors from the watercraft devices via the onboard network 77 (an example of the information collection process). A periodic collection interval for the periodic collection is shorter than the periodic transmission interval.

Examples of the periodic transmission information are as follows. Such information can be used for the troubleshooting, the product development, and the like. Further, information followed by “maintenance time estimation” in parentheses can be used to estimate the maintenance time.

A requested steering angle, an actual steering angle, a steering wheel angle, a fuel pressure feedback value, an engine speed (maintenance time estimation), an intake pressure, an outboard motor trim angle, an oil pressure, a coolant pressure (maintenance time estimation), a coolant temperature, a total operation period (maintenance time estimation), a shift position (forward, reverse or neutral shift position), a fuel consumption rate (maintenance time estimation), a fuel tank type, a fuel level, a residual fuel amount, a battery voltage, a deviation from a target azimuth, a watercraft log speed, a fresh water level, a waste water level, a power generator fuel level, a trouble code (maintenance time estimation), a residual battery capacity (maintenance time estimation), a watercraft ground speed (maintenance time estimation), a water depth, a water temperature, a watercraft pitch angle, a watercraft roll angle, a target steering angle, a deviation from a target azimuth, a target course, a steering electric current, a steering voltage, an ignition timing (maintenance time estimation), a throttle valve opening degree, a fuel injection period (maintenance time estimation), a lever angle (accelerator opening degree), a shift lever position, a fuel pressure (maintenance time estimation), an ISC (Idling Speed Control) target valve opening degree, a requested shift position, an ISC valve opening degree, an ISC target speed, a requested throttle valve opening degree, an atmospheric pressure, an intake temperature, an intake cam timing, a TPS (throttle position sensor) voltage, an engine temperature (maintenance time estimation), a steering motor duty value, and a joystick angle.

FIG. 8 is a flowchart that describes an example of the termination process (Step S11 in FIG. 6) to be performed by the communication terminal 1 when the termination of the use of the onboard system 80 is detected. If the termination of the use of the onboard system 80 is detected (YES in Step S10 in FIG. 6), the communication terminal 1 transmits the termination transmission information to the server 2. More specifically, predefined information classified as the termination transmission information is extracted from the information stored in the memory 12 by the information collection process (Step S8 in FIG. 6) (Step S31, the function of the classifier 20), and the extracted information is transmitted as the termination transmission information to the server 2 (Step S32, the function of the termination transmitter 19). Thereafter, the communication terminal 1 may be shifted to a sleep mode (energy saving mode) (Step S33). The termination transmission information mainly includes information serving as an index to estimate the maintenance time.

Examples of the termination transmission information are as follows. Such information can be used for the troubleshooting, the product development, and the like. Further, information followed by “maintenance time estimation” in parentheses can be used to estimate the maintenance time.

A fuel tank volume, a load-based steering use period (maintenance time estimation), a total steering operation angle (maintenance time estimation), a maximum engine speed (maintenance time estimation), an over-revolution count (maintenance time estimation), an overheat count (maintenance time estimation), a lower oil pressure count (maintenance time estimation), a knocking control count (maintenance time estimation), a rapid acceleration count (maintenance time estimation), a reverse rotation count (maintenance time estimation), an engine speed-based operation period (maintenance time estimation), a shift count (maintenance time estimation) and a start count (maintenance time estimation). The information about the fuel tank volume may be used together with the information about the residual fuel amount included in the periodic transmission information to determine whether or not the user (typically, the owner of the watercraft 5) needs refueling before using the watercraft 5 next (a kind of maintenance in a broader sense). In a marina at which the watercraft 5 is moored, a marina staff member may refuel the watercraft 5.

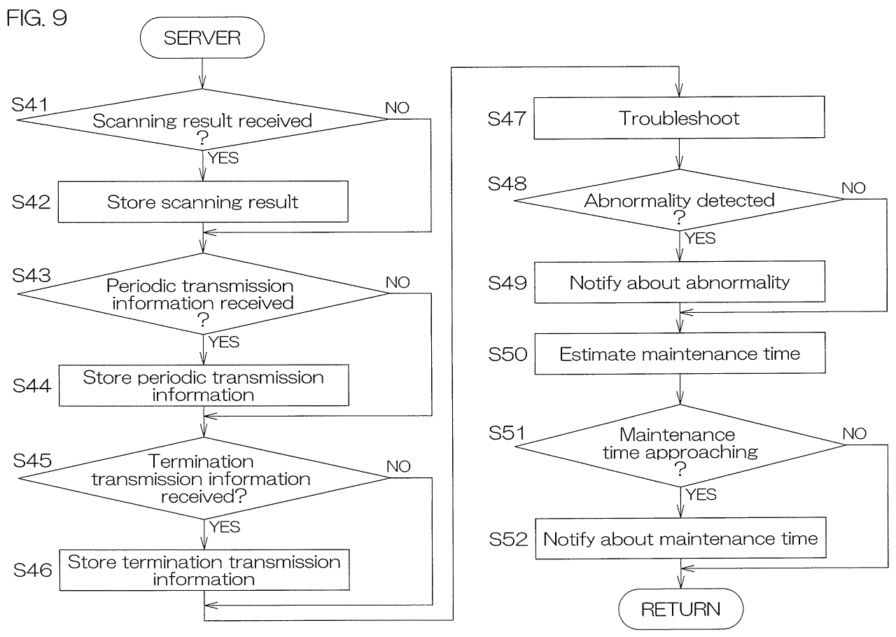

FIG. 9 is a flowchart that describes an exemplary process to be performed by the server 2, mainly showing a process to be periodically performed by the processor 21 (see FIG. 3). The server 2 receives the scanning result data from the communication terminal 1 of the watercraft 5 (Step S41), and accumulates the received scanning result data in the storage 23 (Step S42). Further, the server 2 receives the periodic transmission information from the communication terminal 1 (Step S43), and registers the received periodic transmission information in the database 23D (Step S44). In addition, the server 2 receives the termination transmission information from the communication terminal 1 (Step S45), and registers the received termination transmission information in the database 23D (Step S46).

Further, the server 2 performs the troubleshooting process based on the information registered in the database 23D (Step S47). If an abnormality is detected by the troubleshooting process (YES in Step S48), the server 2 performs the abnormality notification process for the notification about the abnormality (Step S49). The abnormality notification process may include one or more of the display on the webpage provided by the server 2, the notification by the application of the user client 3U, or the transmission of mail to the dealer or the user (or the owner).

Further, the server 2 performs the maintenance time estimation process based on the information registered in the database 23D (Step S50). The server 2 further determines whether or not the maintenance time is approaching (Step S51). If the maintenance time is approaching, the server 2 performs the maintenance time notification process (Step S52). The maintenance time notification process may include one or more of the display on the webpage provided by the server 2, the notification by the application of the user client 3U, or the transmission of mail to the dealer or the user (or the owner). For the determination of whether or not the maintenance time is approaching, the server 2 may, for example, compare an index value for the maintenance time estimation with a threshold.

In this example embodiment, as described above, the onboard system 80 includes the plurality of watercraft devices connected to the onboard network 77, and the communication terminal 1 is included as one of the watercraft devices. The communication terminal 1 is communicable with the other watercraft devices via the onboard network 77, and is communicable with the server 2 provided outside the watercraft 5. In this example embodiment, the communication terminal 1 performs the system scanning process to collect the information about the watercraft devices, and transmits the scanning result to the server 2. Further, the communication terminal 1 performs the information collection process to collect the information from the watercraft devices connected to the onboard network 77 during the operation of the onboard system 80. A portion of the collected information is transmitted to the server 2 by the periodic transmission process, and another portion of the collected information is transmitted to the server 2 by the termination transmission process. The server 2 receives the information transmitted from the communication terminal 1, and registers the received information in the storage 23.

The communication terminal 1 functions to detect the termination of the use of the onboard system 80. Upon the detection of the termination of the use of the onboard system 80, the communication terminal 1 performs the termination transmission process to transmit the information collected so far from the watercraft devices to the server 2. Thus, the information about the watercraft devices is transmitted to the server 2 when the onboard system 80 is terminated. Therefore, the latest information can be accumulated in the server 2, even if the amount of the periodic transmission information is reduced. This makes it possible to timely update the information accumulated in the server 2 while preventing the communication traffic or the data processing load from being excessively increased.

The communication terminal 1 classifies the collected information into the periodic transmission information and the termination transmission information, and performs the periodic transmission process and the termination transmission process, respectively, to transmit the periodic transmission information and the termination transmission information to the server 2. Therefore, the periodic transmission interval is set to a relatively short period (e.g., about 10 minutes) and the information indicating the state of the onboard system 80 in use (i.e., the information indicating the operation state of the watercraft 5 during traveling) is classified as the periodic transmission information such that the information about the constantly changing state of the onboard system 80 can be accumulated in the server 2 substantially on a real time basis. On the other hand, where non-real time information is classified as the termination transmission information and is not periodically transmitted, for example, it is possible to reduce the communication traffic and correspondingly alleviate the processing load on the server 2 in the periodic transmission process.

The termination transmission information preferably includes one or more of the maximum engine speed, the over-revolution count, the overheat count, the lower oil pressure count, the knocking control count, the rapid acceleration count, the reverse rotation count, the engine speed range-based operation period, the shift count, the start count, or the fuel tank volume. Thus, the latest information about the engine is registered in the server 2 by the termination transmission process such that the server 2 can perform processes with the use of the latest information about the engine. Specifically, the server 2 can estimate the maintenance time of the engine in the maintenance time estimation process, and can notify the user or the like about the estimated engine maintenance time.

Further, the termination transmission information preferably includes one or more of the load range-based steering actuator driving period or the total steering operation angle. Thus, the server 2 can perform processes with the use of the latest information about the steering device. For example, the server 2 can estimate the maintenance time of the steering device in the maintenance time estimation process, and can notify the user or the like about the estimated maintenance time.

On the other hand, the periodic transmission information preferably includes at least one of the engine speed, the coolant pressure, the total engine operation period, the fuel consumption rate, the trouble code, the residual battery capacity, the watercraft speed, the ignition timing, the fuel injection period, the fuel pressure or the engine temperature. Thus, the information about the engine can be accumulated in the server 2 at the periodic transmission interval. Thus, a change in the information can be accumulated in the server 2 during the use of the onboard system 80. The server 2 can perform processes based on the accumulated information, for example, to determine whether or not any abnormality is present or whether or not a maintenance is necessary, to estimate the maintenance time and to notify the user or the like about the presence/absence of the abnormality, the necessity/unnecessity of the maintenance and/or the maintenance time.

The termination transmission information preferably includes information usable as the index to estimate the maintenance times of the watercraft devices included in the onboard system 80 (for the inspection, the parts replacement and the like). Thus, the latest information usable as the index to estimate the maintenance times of the watercraft devices (for the inspection, the parts replacement and the like) can be accumulated in the server 2 by the termination transmission process. Thus, the server 2 can properly perform the maintenance time estimation process.

In this example embodiment, the server 2 performs the notification process to notify about the maintenance time based on the termination transmission information. Therefore, the maintenance time can be properly estimated based on the information accumulated in the server 2 by the termination transmission process, so that the user, the owner, the dealer or the like can be notified about the properly estimated maintenance time. Thus, the user or the like can timely take measures for the maintenance.

For comparison, consideration is given to a case in which the information to be used as the index to estimate the maintenance time is transmitted to the server 2 from the communication terminal 1 not at the termination of the use of the onboard system 80 but at the startup (the start of the use) of the onboard system 80. In this case, there is a possibility that, even if the user or the like should be notified about the maintenance time at the termination of the use of the onboard system 80, the notification is not provided to the user or the like until the onboard system 80 is next started. Particularly, pleasure boats are not constantly used all year round, but the use frequency of the pleasure boats is high in the summer season (during the on-season) and is substantially zero in the winter season (during the off-season). In the worst case, the use of such a pleasure boat is likely to be limited due to the maintenance because the notification about the maintenance time to be provided at the end of the on-season is provided at the beginning of the next on-season. The aforementioned example embodiments in which the termination transmission process is performed can solve this problem.

In another comparative example, consideration is given to a case in which the termination transmission process is not performed but the information required to estimate the maintenance time is transmitted to the server 2 from the communication terminal 1 by the periodic transmission process. In this case, the amount of the information to be transmitted to the server 2 by the periodic transmission process (communication traffic) is increased, and the processing load on the server 2 is increased. The aforementioned example embodiments in which the termination transmission process is performed can alleviate this problem.

In this example embodiment, the communication terminal power supply 89 maintains the power supply to the communication terminal 1 even after the termination of the use of the onboard system 80. More specifically, the communication terminal power supply 89 maintains the power supply to the communication terminal 1 at least until the termination transmission process ends. Thus, the power supply to the communication terminal 1 is maintained even after the termination of the use of the onboard system 80, so that the communication terminal 1 can reliably perform the termination transmission process.

While example embodiments of the present invention have thus been described, the present invention may be embodied in some other ways.

In the aforementioned example embodiments, the outboard motors are used as the propulsion device by way of example, but the propulsion device provided on the watercraft may be of any of various types such as inboard motors, inboard/outboard motors and waterjet propulsion devices.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft information collecting system comprising:
an onboard system including a plurality of watercraft devices on a watercraft, an onboard network on the watercraft and connected to the plurality of watercraft devices, and a communication terminal communicable with the plurality of watercraft devices via the onboard network; and
a server outside the watercraft and communicable with the communication terminal; wherein
the communication terminal is configured or programmed to perform an information collection process to collect information about the plurality of watercraft devices, a use termination detection process to detect a termination of use of the onboard system, and an information transmission process to transmit the information collected by the information collection process to the server;
the server is configured or programmed to register the information transmitted from the communication terminal in a storage; and
the information transmission process includes a termination transmission process to transmit the information collected by the information collection process to the server in response to the detection of the termination of the use of the onboard system by the use termination detection process.

2. The watercraft information collecting system according to claim 1, wherein
the communication terminal is configured or programmed to classify the information collected by the information collection process into periodic transmission information and termination transmission information;
the information transmission process further includes a periodic transmission process to transmit the periodic transmission information to the server at a predetermined periodic transmission interval during the use of the onboard system; and
the termination transmission process is performed to transmit the termination transmission information to the server.

3. The watercraft information collecting system according to claim 2, wherein
the plurality of watercraft devices include a propulsion device including an engine as a power source; and
the termination transmission information includes one or more of a maximum engine speed, an over-revolution count, an overheat count, a lower oil pressure count, a knocking control count, a rapid acceleration count, a reverse rotation count, an engine speed range-based operation period, a shift count, a start count, or a fuel tank volume.

4. The watercraft information collecting system according to claim 2, wherein
the plurality of watercraft devices include a steering device including a steering actuator; and
the termination transmission information includes one or more of a load range-based steering actuator driving period or a total steering operation angle.

5. The watercraft information collecting system according to claim 2, wherein
the plurality of watercraft devices include a propulsion device including an engine as a power source; and
the periodic transmission information includes one or more of an engine speed, a coolant pressure, a total engine operation period, a fuel consumption rate, a trouble code, a residual battery capacity, a watercraft speed, an ignition timing, a fuel injection period, a fuel pressure, or an engine temperature.

6. The watercraft information collecting system according to claim 2, wherein the termination transmission information includes information usable to estimate a maintenance time of any of the plurality of watercraft devices in the onboard system.

7. The watercraft information collecting system according to claim 6, wherein the server is configured or programmed to perform a notification process to notify the maintenance time based on the termination transmission information.

8. The watercraft information collecting system according to claim 1, further comprising a communication terminal power supply to maintain a power supply to the communication terminal at least until the termination transmission process ends after the termination of the use of the onboard system.

9. A watercraft information collecting system comprising:
an onboard system including a plurality of watercraft devices on a watercraft, an onboard network on the watercraft and connected to the plurality of watercraft devices, and a communication terminal communicable with the plurality of watercraft devices via the onboard network; and
a server outside the watercraft and communicable with the communication terminal; wherein
the communication terminal is configured or programmed to perform an information collection process to collect information about the plurality of watercraft devices, a use termination detection process to detect a termination of use of the onboard system, and an information transmission process to transmit the information collected by the information collection process to the server; and
the server is configured or programmed to register the information transmitted from the communication terminal in a storage.

10. A watercraft comprising:
a hull; and
the onboard system for use in the watercraft information collecting system according to claim 1.

11. A watercraft comprising:
a hull; and
the onboard system for use in the watercraft information collecting system according to claim 9.

12. The communication terminal for use in the watercraft information collecting system according to claim 1.

13. The server for use in the watercraft information collecting system according to claim 1.

14. A communication terminal to be mounted on a watercraft and communicable with a server, the communication terminal comprising:
a communication interface to be connected to an onboard network on the watercraft;
a wireless communicator to communicate with the server; and
a processor configured or programmed to function as:
an information collector to collect information about watercraft devices on the watercraft and connected to the onboard network via the communication interface;
a use termination detector to detect a termination of use of an onboard system; and
an information transmitter to cause the wireless communicator to transmit the information collected by the information collector to the server.

15. The communication terminal according to claim 14, wherein the information transmitter is configured or programmed to perform a termination transmission process to transmit the information collected by the information collector to the server in response to the detection of the termination of the use of the onboard system by the use termination detector.

16. The communication terminal according to claim 15, wherein
the processor is configured or programmed to classify the information collected by the information collector into periodic transmission information and termination transmission information; and
the information transmitter is configured or programmed to perform a periodical transmission process to transmit the periodic transmission information to the server at a predetermined periodic transmission interval during the use of the onboard system and, in the termination transmission process, transmit the termination transmission information to the server.
